(19) United States
(12) Patent Application Publication
(10) Pub. No.: US 2011/0007639 A1
(43) Pub. Date: Jan. 13, 2011

(54) METHODS AND APPARATUS FOR DETECTING IDENTIFIERS

(75) Inventor: Thomas Richardson, South Orange, NJ (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/500,785

(22) Filed: Jul. 10, 2009

(51) Int. Cl. H04L 12/26

(52) U.S. Cl. 370/252

(57) ABSTRACT

Methods and apparatus related to detecting identifiers in a wireless communications system are described. Various methods and apparatus are well suited to a decentralized peer to peer wireless communications system in which devices monitor for and attempts to detect peer discovery identifiers of interest. Identifiers correspond to identifier bit sequences which are intentionally structured to appear to be random sequences. A portion of an identifier bit sequence is broadcast in a peer discovery interval. A receiver device, searching for a particular bit sequence of interest, tries to match received peer discovery bit sequence portion against a corresponding portion of the bit sequence of interest. Matching bits are determined on a per portion basis, and an updated match quality value is determined. A match or mismatch condition is determined as a function of the updated match quality value.

### FIELD

Various embodiments relate to wireless communications, and more particularly, to methods and apparatus which can be used for detecting identifiers.

### BACKGROUND

In the field of wireless communications there has been a trend to make spectrum available for use by various types of networks in addition to conventional cellular networks. One such network type which has been gaining in popularity and utilization is a peer to peer network, e.g., peer to peer networks lacking centralized control. It would be beneficial if a device in such a network could be made aware of the presence of other devices in its vicinity with which it has a common interest. There may potentially be many devices in the network which would like to broadcast information, e.g., an identifier, to be discovered by other devices. Accordingly, the amount of air link resources that can be allocated to an individual device may be limited. This limited amount of air link resource allocated to an individual device limits the amount of information that can be communicated and/or the amount of resources that can be allocated for coding redundancy to improve reliability. Different devices in the decentralized network trying to discover one another may not have established connections with one another with well defined and/or stable channel conditions.

It is desirable that this broadcast discovery information be communicated in a robust and reliable fashion. However, in a decentralized network this a challenging task. In view of the resource limitations and the wide range of possibilities regarding channel conditions, reliable detection of discovery identifiers may be problematic. Based on the above, it should be appreciated that there is a need for new methods and apparatus for identifier detection in a wireless communications system.

### SUMMARY

Methods and apparatus related to detecting identifiers in a wireless communications system are described. Various methods and apparatus are well suited to a decentralized peer to peer wireless communications system in which devices monitor for and attempt to detect peer discovery identifiers of interest. In some embodiments, the peer to peer wireless communications system implements a peer to peer timing structure including peer discovery intervals in which a wireless communications device is given an opportunity to broadcast a relatively small amount of information on an individual peer discovery segment, with the peer discovery intervals occurring relatively frequently. The peer discovery intervals may be interspersed between other types of intervals including one or more peer to peer traffic intervals. In various embodiments, the resources allocated to peer discovery occupy a relatively small amount of the overall air link resources in the peer to peer timing structure, e.g., less than 10%.

In some embodiments, an identifier is, e.g., a 128 bit identifier representing peer discovery information to be communicated, e.g., a device identifier, a user identifier, a group identifier, a common interest, an association, a service offered, a request, a product, etc. In some embodiments, an identifier corresponds to an identifier bit sequence, and the identifier bit sequence is intentionally chosen to appear essentially random. This characteristic of the identifier bit sequence appearing essentially random facilitates detection. Mismatch conditions will tend, over the long term, toward a 50% bit error rate, while match conditions, will tend, over the long term, toward a bit error rate which is a function of the channel noise. The identifier bit sequence includes a plurality of portions, with different portions being transmitted on different peer discovery segments. For example, a transmitting device transmits a first portion of its identifier bit sequence on a first segment of a first peer discovery communications channel during a first peer discovery interval and transmits a second portion of its identifier bit sequence on a second segment of the first peer discovery communications channel during a second peer discovery interval.

A device attempting to detect identifiers receives an identifier bit sequence portion on a communications channel and compares it to a portion of a known identifier bit sequence of interest. A number of matching bits for the portion is determined. An updated match quality value corresponding to the received identifier bit sequence and the bit sequence of interest is determined as a function of the determined number of matching bits. A match and/or mismatch condition is determined as a function of the determined updated match quality value. In various embodiments, different threshold limits are used to declare a match condition and to declare a mismatch condition. The process is repeated for subsequent peer discovery intervals. In contrast to systems where a perfect match between a received value and an expected value are required for a match to be declared, in some embodiments described herein, based on the determined match quality value and the threshold limit being used to declare a match, a match may be declared, at least in some embodiments, when less than all the bits of a received identifier bit sequence portion match a corresponding portion of a known identifier bit sequence of interest, e.g., which may occur in the case of transmission errors.

An exemplary identifier detection method, in accordance with some embodiments, comprises: receiving a first identification signal communicating a portion of a first identifier bit sequence during a first time period; determining a first number of matching bits of the received portion of the first identifier bit sequence which match bits of a first portion of a first identifier bit sequence of interest corresponding to said first time period; and updating a first match quality measure value corresponding to the first identifier bit sequence of interest based on the determined first number of matching bits. An exemplary communications device, in accordance with some embodiments, comprises at least one processor configured to: receive a first identification signal communicating a portion of a first identifier bit sequence during a first time period; determine a first number of matching bits of the received portion of the first identifier bit sequence which match bits of a first portion of a first identifier bit sequence of interest corresponding to said first time period; and update a first match quality measure value corresponding to the first identifier bit sequence of interest based on the determined first number of matching bits. The exemplary communications device further comprises memory coupled to said at least one processor.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE FIGURES

FIG. 1 is a drawing of an exemplary wireless communications system in accordance with an exemplary embodiment.

FIG. 2A is a first part of a flowchart of an exemplary method of operating a communications device in accordance with an exemplary embodiment.

FIG. 2B is a second part of a flowchart of an exemplary method of operating a communications device in accordance with an exemplary embodiment.

FIG. 2C is a third part of a flowchart of an exemplary method of operating a communications device in accordance with an exemplary embodiment.

FIG. 2D is a fourth part of a flowchart of an exemplary method of operating a communications device in accordance with an exemplary embodiment.

FIG. 3 is a drawing of an exemplary communications device, in accordance with an exemplary embodiment.

FIG. 4A is a first part of an assembly of modules which can, and in some embodiments is, used in the communications device illustrated in FIG. 3.

FIG. 4B is a second part of an assembly of modules which can, and in some embodiments is, used in the communications device illustrated in FIG. 3.

FIG. 4C is a third part of an assembly of modules which can, and in some embodiments is, used in the communications device illustrated in FIG. 3.

FIG. 4D is a fourth part of an assembly of modules which can, and in some embodiments is, used in the communications device illustrated in FIG. 3.

FIG. 5 is a drawing illustrating an exemplary peer to peer recurring timing structure, exemplary received bits from detected identification signals and exemplary test patterns.

FIG. 6 illustrates an exemplary entropy coding table used in some embodiments, for portion matching encoding.

FIG. 7 is a drawing illustrating a match test example for 3 portions of a first received sequence using the entropy coding table shown in FIG. 6 in which a match condition is determined.

FIG. 8 is a drawing illustrating a match test example for 3 portions of a first received sequence using the entropy coding table shown in FIG. 6 in which a mismatch condition is determined.

### DETAILED DESCRIPTION

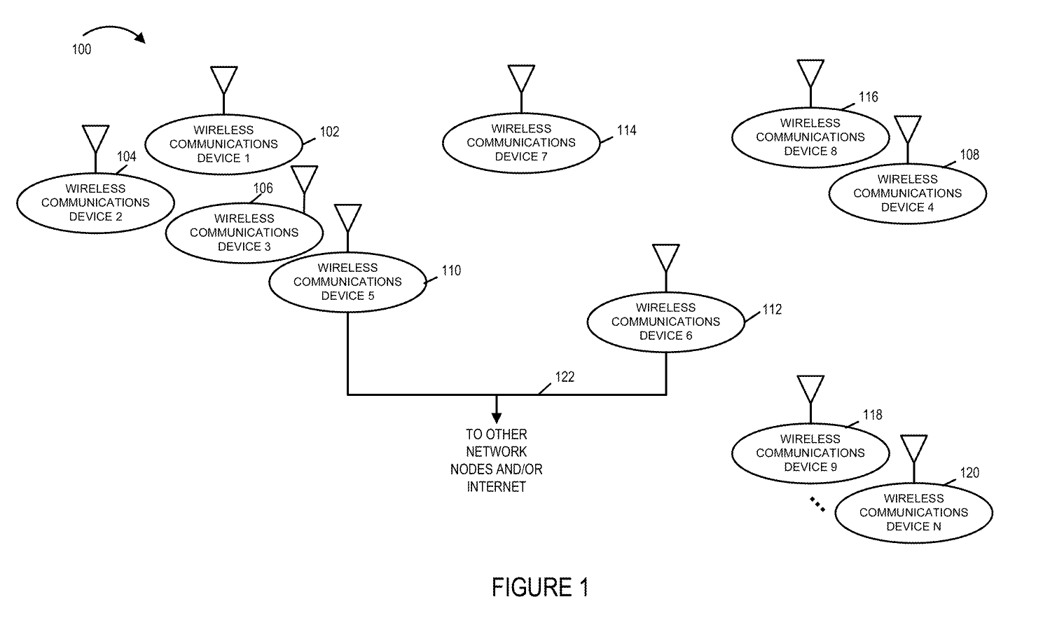

FIG. 1 is a drawing of an exemplary wireless communications system 100 in accordance with an exemplary embodiment. Exemplary wireless communications system 100 includes a plurality of wireless communications devices (wireless communications device 1 102, wireless communications device 2 104, wireless communications device 3 106, wireless communications device 4 108, wireless communications device 5 110, wireless communications device 6 112, wireless communications device 7 114, wireless communications device 8 116, wireless communications device 9 118, . . . , wireless communications device N 120. Some of the wireless communications devices of system 100, e.g., device 5 110 and device 6 112, are coupled to other network nodes and/or the Internet via backhaul network 122. Some of the wireless communications devices of system 100 are mobile devices, e.g., devices (102, 104, 106, 108, 114, 116, 118, 120).

The wireless communications devices (102, 104, 106, 108, 110, 112, 114, 116, 118, 120) support peer to peer communications and implements a peer to peer timing structure. The peer to peer communications system, in some embodiments, implements a decentralized approach to resource allocation. An exemplary air link resource is, e.g., a set of time-frequency transmission units associated with a resource identifier.

One type of air link resource, in some embodiments, is a peer discovery air link resource. An identifier bit sequence may be communicated using a plurality of portions with different portions communicated over different segments in a set of segments corresponding to the resource identifier. Identification signals, e.g., peer discovery identification signals, conveyed on peer discovery air link resources, may include signals conveying private and/or public identifiers associated with a wireless communications device. Through peer discovery operations a wireless communications device may find other wireless communications devices of interest. For example, a wireless communications device may search for private and/or public identifiers corresponding friends, relatives, business associates, group members, common interests, businesses, services, etc. A wireless communications device may monitor for discovery signals, decode detected discovery signals and check recovered identifiers against identifiers of interest. Based on a match the wireless communications device may establish a peer to peer connection and/or communicate peer to peer traffic channel signals.

In some embodiments, an identification signal communicates a portion of an identifier bit sequence. In some such embodiments, portions of received identifier bit sequences are compared against portions of identifier bit sequences of interest. In various embodiments, a matching quality measure value is determined based on a determined number of matching bits. A match and/or mismatch determination is made based on a determined match quality measure value.

In some embodiments, the characteristics of an identification bit sequence is intentionally chosen such that on average the likelihood of a “1” is substantially the same as a likelihood of a “0”, and different identification bit sequences are random. In such a situation, with regard to matching bits in a received bit portion of an identification bit sequence compared to a known bit sequence of interest, for a mismatch condition, there is tendency toward half the number of received bits matching. In various embodiments, this characteristic is taken in consideration when updating a match quality measure value.

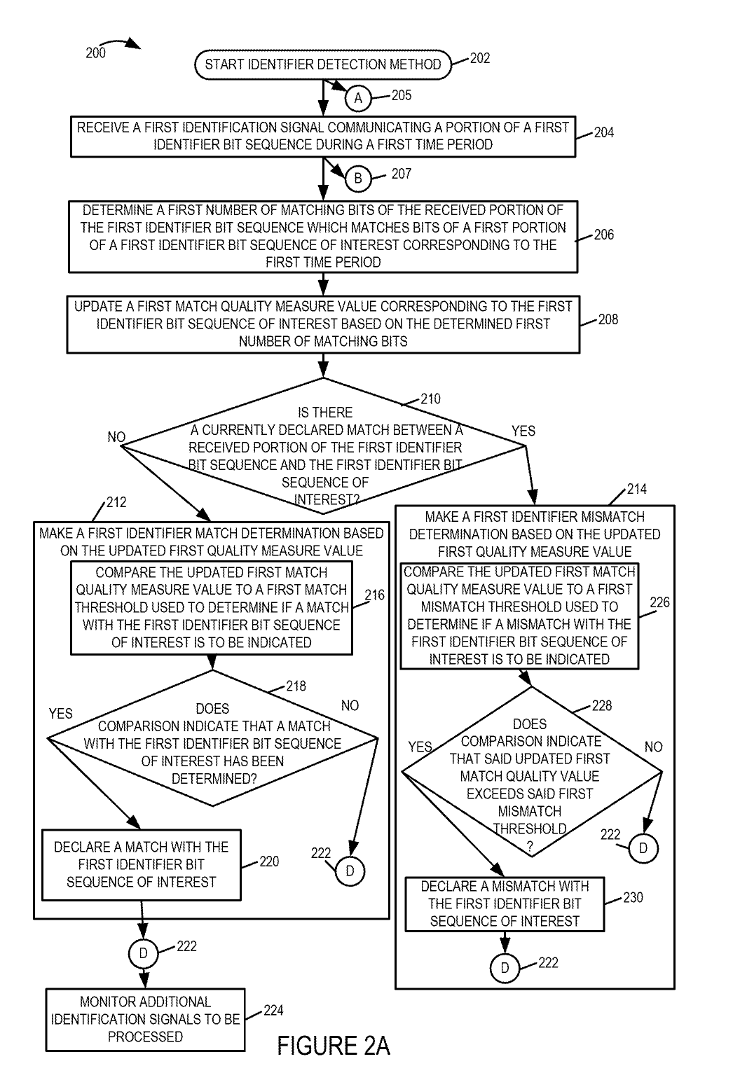

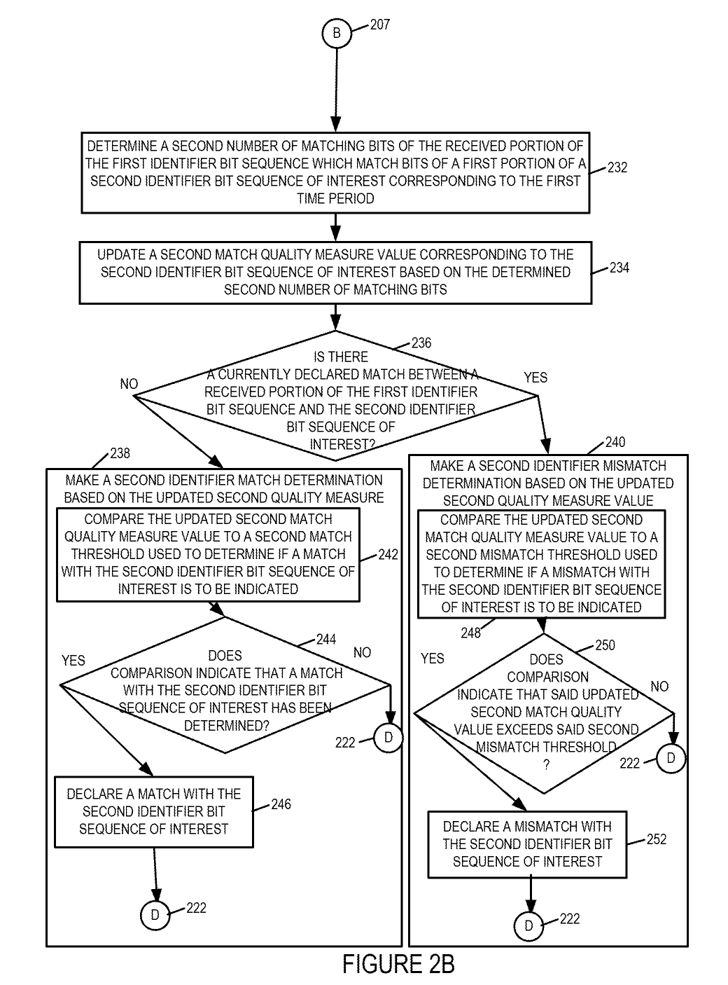

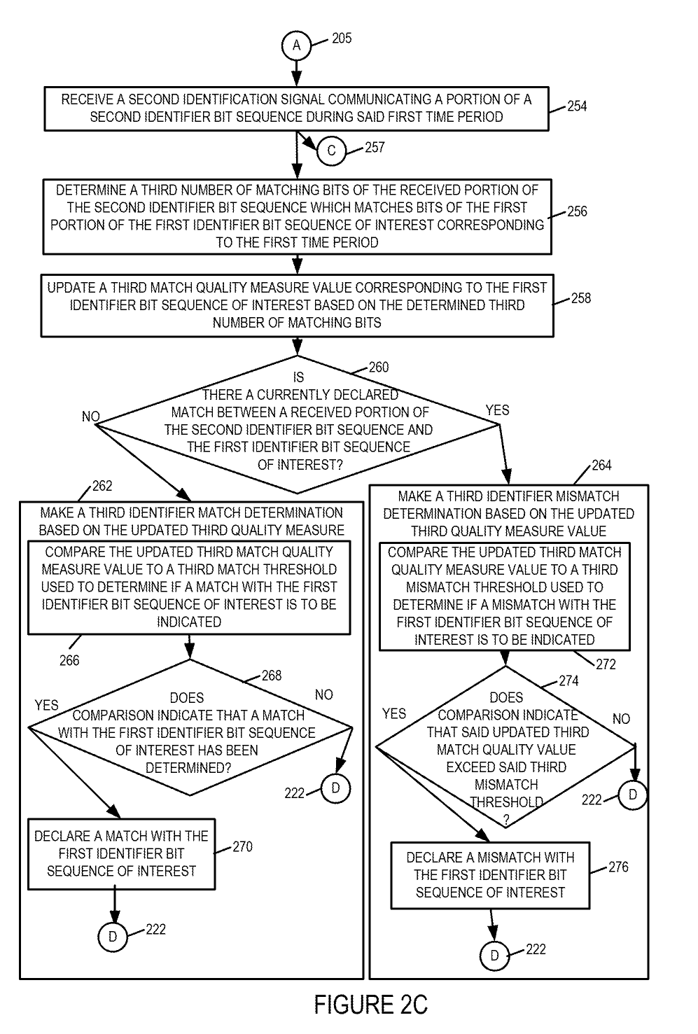

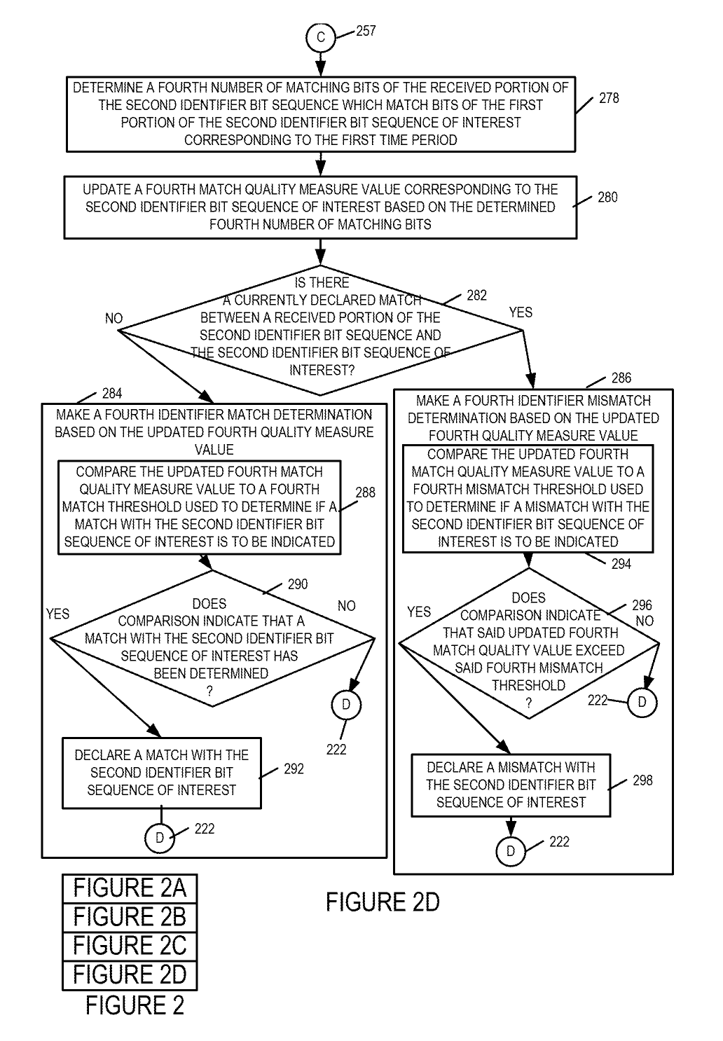

FIG. 2, comprising the combination of FIG. 2A, FIG. 2B, FIG. 2C and FIG. 2D, is a flowchart 200 of an exemplary method of operating a wireless communications device to perform an identifier detection method. Operation starts in step 202, where the communications device is powered on and initialized. Operation proceeds from step 202 to step 204 and to step 254 via connecting node A 205.

Returning to step 204, in step 204 the communications device receives a first identification signal communicating a portion of a first identifier bit sequence during a first time period. Operation proceeds from step 204 to step 206 and to step 232 via connecting node B 207.

Returning to step 206, in step 206, the communications device determines a first number of matching bits of the received portion of the first identifier bit sequence which matches bits of a first portion of a first identifier bit sequence of interest corresponding to the first time period. Then, in step 208, the communications device updates a first match quality measure value corresponding to the first identifier bit sequence of interest based on the determined first number of matching bits. Operation proceeds from step 208 to step 210.

In step 210 the communications device controls operation as a function of whether there is a currently declared match between a received portion of the first identifier bit sequence and the first identifier bit sequence of interest. If there is not a currently declared match between a received portion of the first identifier bit sequence and the first identifier bit sequence of interest, then operation proceeds from step 210 to step 212; however, if there is a currently declared match between a received portion of the first identifier bit sequence and the first identifier bit sequence of interest then operation proceeds from step 210 to step 214.

Returning to step 212, in step 212 the communications device makes a first identifier match determination based on the updated first quality measure value. Step 212 includes sub-steps 216, 218 and 220. In sub-step 216 the communications device compares the updated first match quality measure value to a first match threshold used to determine if a match with the first identifier bit sequence of interest is to be indicated. In some embodiments, the first match threshold is based on an expected mismatch rate. For example, a crude channel noise estimate, based on a crude SNR estimate, in some embodiments, is used to determine an expected bit error rate for the communications channel under a matching scenario, e.g., a 10% mismatch may be expected due to channel noise when the received bit sequence matches the bit sequence of interest. In various embodiments, the first match threshold is varied as a function of the number of bits used to generate the first match quality measure value. In some embodiments, the first match threshold is application dependent. For example, in some such embodiments, the first match threshold will depend on the application's willingness to accept a particular false alarm rate. Operation proceeds from sub-step 216 to sub-step 218. In sub-step 218 the communications device determines whether or not the comparison of sub-step 216 indicates that a match with the first identifier bit sequence of interest has been determined. If a comparison indicates that a match has been determined, then operation proceeds from sub-step 218 to sub-step 220; however, if the comparison does not indicate that a match has been determined, then operation proceeds from sub-step 218 via connecting node D 222 to step 224. Returning to sub-step 220, in sub-step 220 the communications device declares a match with the first identifier bit sequence of interest. Operation proceeds from sub-step 220 via connecting node D 222 to step 224. In step 224 the communications device monitors additional identification signals to be processed.

Returning to step 214, in step 214 the communications device makes a first identifier mismatch determination based on the updated first quality measure value. Step 214 includes sub-steps 226, 228 and 230. In sub-step 226 the communications device compares the updated first match quality measure value to a first mismatch threshold used to determine if a mismatch with the first identifier bit sequence of interest is to be indicated. Operation proceeds from step 226 to step 228. In step 228 if the comparison of step 226 indicates that the updated first match quality value exceeds said first mismatch threshold, then operation proceeds from step 228 to step 230, where the communications device declares a mismatch with the first identifier bit sequence of interest. Operation proceeds from sub-step 220 to connecting node D 222. However, if the comparison of step 226 indicates that the updated first match quality value does not exceed the first mismatch threshold, then operation proceeds from sub-step 228 to connecting node D 222. Operation proceeds from connecting node D 222 to step 224 in which the communications device monitors for additional identification signal to be processed.

Returning to step 232, in step 232, the communications device determines a second number of matching bits of the received portion of the first identifier bit sequence which matches bits of a first portion of a second identifier bit sequence of interest corresponding to the first time period. Then, in step 234, the communications device updates a second match quality measure value corresponding to the second identifier bit sequence of interest based on the determined second number of matching bits. Operation proceeds from step 234 to step 236.

In step 236 the communications device controls operation as a function of whether there is a currently declared match between a received portion of the first identifier bit sequence and the second identifier bit sequence of interest. If there is not a currently declared match between a received portion of the first identifier bit sequence and the second identifier bit sequence of interest, then operation proceeds from step 236 to step 238; however, if there is a currently declared match between a received portion of the first identifier bit sequence and the second identifier bit sequence of interest then operation proceeds from step 236 to step 240.

Returning to step 238, in step 238 the communications device makes a second identifier match determination based on the updated second quality measure value. Step 238 includes sub-steps 242, 244 and 246. In sub-step 242 the communications device compares the updated second match quality measure value to a second match threshold used to determine if a match with the second identifier bit sequence of interest is to be indicated. Operation proceeds from sub-step 242 to sub-step 244. In sub-step 244 the communications device determines whether or not the comparison of sub-step 242 indicates that a match with the second identifier bit sequence of interest has been determined. If a comparison indicates that a match has been determined, then operation proceeds from sub-step 244 to sub-step 246; however, if the comparison does not indicate that a match has been determined, then operation proceeds from sub-step 244 via connecting node D 222 to step 224. Returning to sub-step 246, in sub-step 246 the communications device declares a match with the second identifier bit sequence of interest. Operation proceeds from sub-step 246 via connecting node D 222 to step 224. In step 224 the communications device monitors additional identification signals to be processed.

Returning to step 240, in step 240 the communications device makes a second identifier mismatch determination based on the updated second quality measure value. Step 240 includes sub-steps 248, 250 and 252. In sub-step 248 the communications device compares the updated second match quality measure value to a second mismatch threshold used to determine if a mismatch with the second identifier bit sequence of interest is to be indicated. Operation proceeds from sub-step 248 to sub-step 250. In sub-step 250 if the comparison of sub-step 248 indicates that the updated second match quality value exceeds said second mismatch threshold, then operation proceeds from sub-step 250 to sub-step 252, where the communications device declares a mismatch with the second identifier bit sequence of interest. Operation proceeds from sub-step 252 to connecting node D 222. However, if the comparison of sub-step 250 indicates that the updated second match quality value does not exceed the second mismatch threshold, then operation proceeds from sub-step 250 to connecting node D 222. Operation proceeds from connecting node D 222 to step 224 in which the communications device monitors for additional identification signal to be processed.

Returning to step 254, in step 254 the communications device receives a second identification signal communicating a portion of a second identifier bit sequence during said first time period. In some such embodiments, the first identification signal of step 204 corresponds to and is received on a first communications channel, and the second identification signal of step 254 corresponds to and is received on a second communications channel, wherein the second communications channel is different from the first communications channel. In some such embodiments, the first and second communications channels are different peer discovery communications channels. In various embodiments, the first time period is a peer discovery time interval. Operation proceeds from step 254 to step 256 and to step 278 via connecting node C 257.

Returning to step 256, in step 256, the communications device determines a first number of matching bits of the received portion of the second identifier bit sequence which matches bits of the first portion of the first identifier bit sequence of interest corresponding to the first time period. Then, in step 258, the communications device updates a third match quality measure value corresponding to the first identifier bit sequence of interest based on the determined third number of matching bits. Operation proceeds from step 258 to step 260.

In step 260 the communications device controls operation as a function of whether there is a currently declared match between a received portion of the second identifier bit sequence and the first identifier bit sequence of interest. If there is not a currently declared match between a received portion of the second identifier bit sequence and the second identifier bit sequence of interest, then operation proceeds from step 260 to step 262; however, if there is a currently declared match between a received portion of the second identifier bit sequence and the first identifier bit sequence of interest then operation proceeds from step 260 to step 264.

Returning to step 262, in step 262 the communications device makes a third identifier match determination based on the updated third quality measure value. Step 262 includes sub-steps 266, 268 and 270. In sub-step 266 the communications device compares the updated third match quality measure value to a third match threshold value to determine if a match with the first identifier bit sequence of interest is to be indicated. Operation proceeds from sub-step 266 to sub-step 268. In sub-step 268 the communications device determines whether or not the comparison of sub-step 266 indicates that a match with the first identifier bit sequence of interest has been determined. If a comparison indicates that a match has been determined, then operation proceeds from step 268 to step 270; however, if the comparison does not indicate that a match has been determined, then operation proceeds from step 268 via connecting node D 222 to step 224. Returning to sub-step 270, in sub-step 270 the communications device declares a match with the first identifier bit sequence of interest. Operation proceeds from sub-step 270 via connecting node D 222 to step 224. In step 224 the communications device monitors additional identification signals to be processed.

Returning to step 264, in step 264 the communications device makes a third identifier mismatch determination based on the updated third quality measure value. Step 264 includes sub-steps 272, 274 and 276. In sub-step 272 the communications device compares the updated third match quality measure value to a third mismatch threshold used to determine if a mismatch with the first identifier bit sequence of interest is to be indicated. Operation proceeds from sub-step 272 to sub-step 274. In sub-step 274 if the comparison of sub-step 272 indicates that the updated third match quality value exceeds said third mismatch threshold, then operation proceeds from sub-step 274 to sub-step 276, where the communications device declares a mismatch with the first identifier bit sequence of interest. Operation proceeds from sub-step 276 to connecting node D 222. However, if the comparison of sub-step 274 indicates that the updated third match quality value does not exceed the third mismatch threshold, then operation proceeds from sub-step 274 to connecting node D 222. Operation proceeds from connecting node D 222 to step 224 in which the communications device monitors for additional identification signal to be processed.

Returning to step 278, in step 278, the communications device determines a fourth number of matching bits of the received portion of the second identifier bit sequence which matches bits of a first portion of the second identifier bit sequence of interest corresponding to the first time period. Then, in step 280, the communications device updates a fourth match quality measure value corresponding to the second identifier bit sequence of interest based on the determined fourth number of matching bits. Operation proceeds from step 280 to step 282.

In step 282 the communications device controls operation as a function of whether there is a currently declared match between a received portion of the second identifier bit sequence and the second identifier bit sequence of interest. If there is not a currently declared match between a received portion of the second identifier bit sequence and the second identifier bit sequence of interest, then operation proceeds from step 282 to step 284; however, if there is a currently declared match between a received portion of the first identifier bit sequence and the second identifier bit sequence of interest then operation proceeds from step 282 to step 286.

Returning to step 284, in step 284 the communications device makes a fourth identifier match determination based on the updated fourth quality measure value. Step 284 includes sub-steps 288, 290 and 292. In sub-step 288 the communications device compares the updated fourth match quality measure value to a fourth match threshold value to determine if a match with the second identifier bit sequence of interest is to be indicated. Operation proceeds from sub-step 288 to sub-step 290. In sub-step 290 the communications device determines whether or not the comparison of sub-step 288 indicates that a match with the second identifier bit sequence of interest has been determined. If a comparison indicates that a match has been determined, then operation proceeds from step 290 to step 292; however, if the comparison does not indicate that a match has been determined, then operation proceeds from step 290 via connecting node D 222 to step 224. Returning to sub-step 292, in sub-step 292 the communications device declares a match with the second identifier bit sequence of interest. Operation proceeds from sub-step 292 via connecting node D 222 to step 224. In step 224 the communications device monitors additional identification signals to be processed.

Returning to step 286, in step 286 the communications device makes a fourth identifier mismatch determination based on the updated fourth quality measure value. Step 286 includes sub-steps 294, 296 and 298. In sub-step 294 the communications device compares the updated fourth match quality measure value to a fourth mismatch threshold used to determine if a mismatch with the second identifier bit sequence of interest is to be indicated. Operation proceeds from sub-step 294 to sub-step 296. In sub-step 296 if the comparison of sub-step 294 indicates that the updated fourth match quality value exceeds said fourth mismatch threshold, then operation proceeds from sub-step 296 to sub-step 298, where the communications device declares a mismatch with the second identifier bit sequence of interest. Operation proceeds from sub-step 298 to connecting node D 222. However, if the comparison of sub-step 294 indicates that the updated fourth match quality value does not exceed the fourth mismatch threshold, then operation proceeds from sub-step 296 to connecting node D 222. Operation proceeds from connecting node D 222 to step 224 in which the communications device monitors for additional identification signal to be processed.

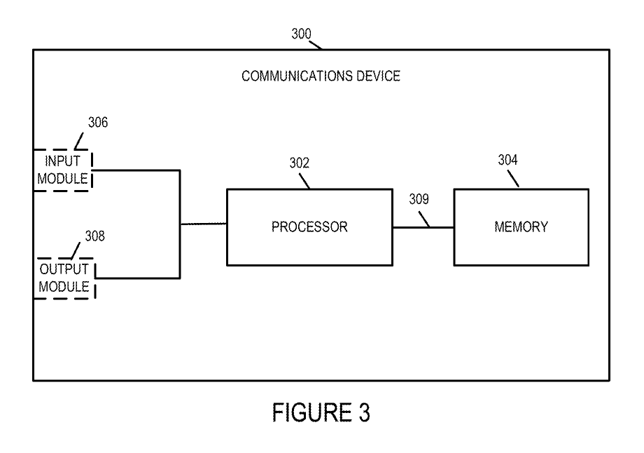

FIG. 3 is a drawing of an exemplary communications device 300, in accordance with an exemplary embodiment. Exemplary communications device 300 is, e.g., one of the wireless communications devices of FIG. 1. Exemplary communications device 300 may, and sometimes does, implement a method in accordance with flowchart 200 of FIG. 2.

Communications device 300 includes a processor 302 and memory 304 coupled together via a bus 309 over which the various elements (302, 304) may interchange data and information. Communications device 300 further includes an input module 306 and an output module 308 which may be coupled to processor 302 as shown. However, in some embodiments, the input module 306 and output module 308 are located internal to the processor 302. Input module 306 can receive input signals. Input module 306 can, and in some embodiments does, include a wireless receiver and/or a wired or optical input interface for receiving input. Output module 308 may include, and in some embodiments does include, a wireless transmitter and/or a wired or optical output interface for transmitting output.

Processor 302 is configured to: receive a first identification signal communicating a portion of a first identifier bit sequence during a first time period; determine a first number of matching bits of the received portion of the first identifier bit sequence which match bits of a first portion of a first identifier bit sequence of interest corresponding to said first time period; and update a first match quality measure value corresponding to the first identifier bit sequence of interest based on the determined first number of matching bits. Processor 302 is further configured to: make a first identifier match determination based on said updated first quality measure value. In various embodiments processor 302 is configured to: compare the updated first match quality measure value to a first match threshold used to determine if a match with the first identifier bit sequence of interest is to be indicated; and declare a match with the first identifier bit sequence of interest when said comparing indicates that a match with the first identifier bit sequence of interest has been determined, as part of being configured to make a first identifier match determination.

In some embodiments, the first match threshold is based on an expected mismatch rate. In various embodiments, the first match threshold is varied as a function of the number of bits used to generate said first match quality measure value. The first match threshold, in some embodiments, is application dependent.

Processor 302 is further configured to: compare an updated first match quality measure value to a first mismatch threshold used to determine if a mismatch with the first identifier bit sequence of interest is to be indicated; and declare a mismatch following declaration of a match with the first identifier bit sequence of interest, when said comparing indicates that said updated match quality measure value exceeds said first mismatch threshold.

In some embodiments, the first identification signal corresponds to a first communications channel, and processor 302 is further configured to: receive, during the first time period, a second identification signal on a second communications channel communicating a portion of a second identifier bit sequence during said first time period, said second communications channel being different from said first communications channel; determine a third number of matching bits of the received portion of the second identifier bit sequence which match bits of a first portion of the first identifier bit sequence of interest corresponding to said first time period; and update a third match quality measure value corresponding to the first identifier bit sequence of interest based on the determined third number of matching bits.

Processor 302 is further configured to: determine a second number of matching bits of the received portion of the first identifier bit sequence which match bits of a first portion of a second identifier bit sequence of interest corresponding to said first time period; and update a second match quality measure value corresponding to the second identifier bit identifier bit sequence of interest based on the determined second number of matching bits; and make a second identifier match determination based on said updated second match quality measure value.

In some embodiments, the channels are different peer discovery channels. In some such embodiments, the first time period is a peer discovery time interval. In various embodiments, the first time period is one of a plurality of peer discovery time intervals in a recurring peer to peer timing structure.

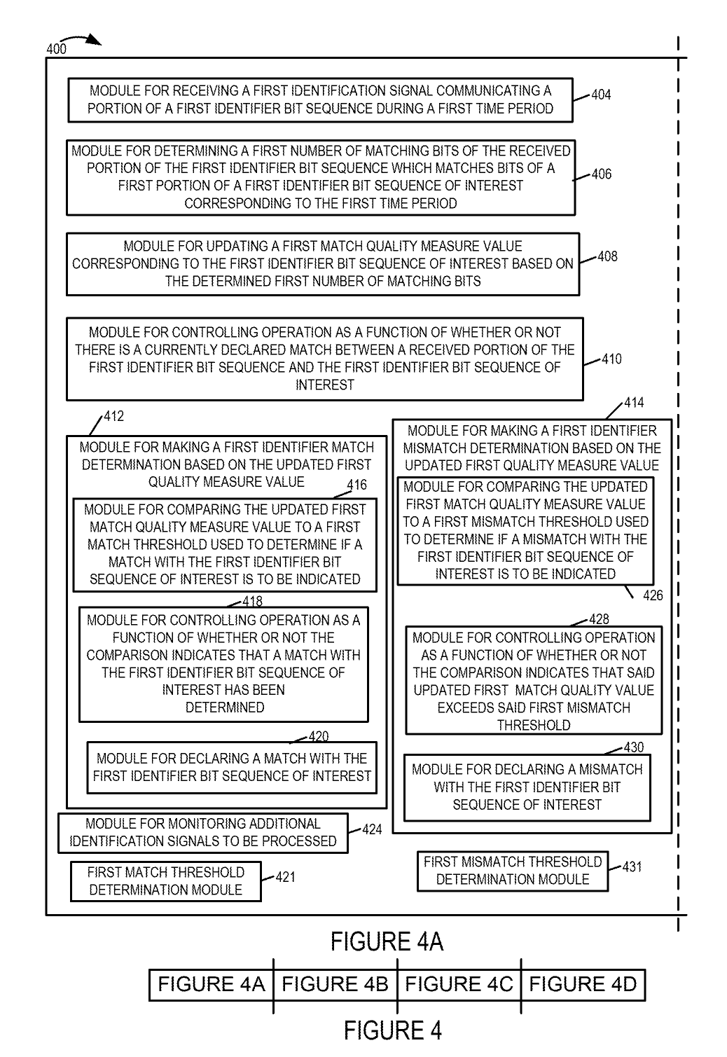

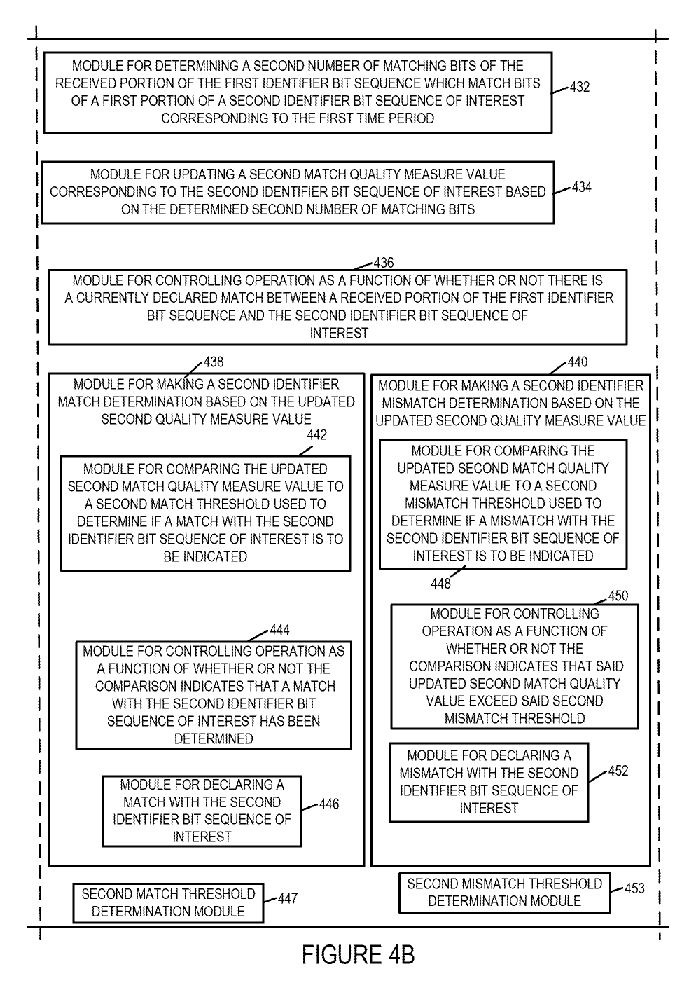

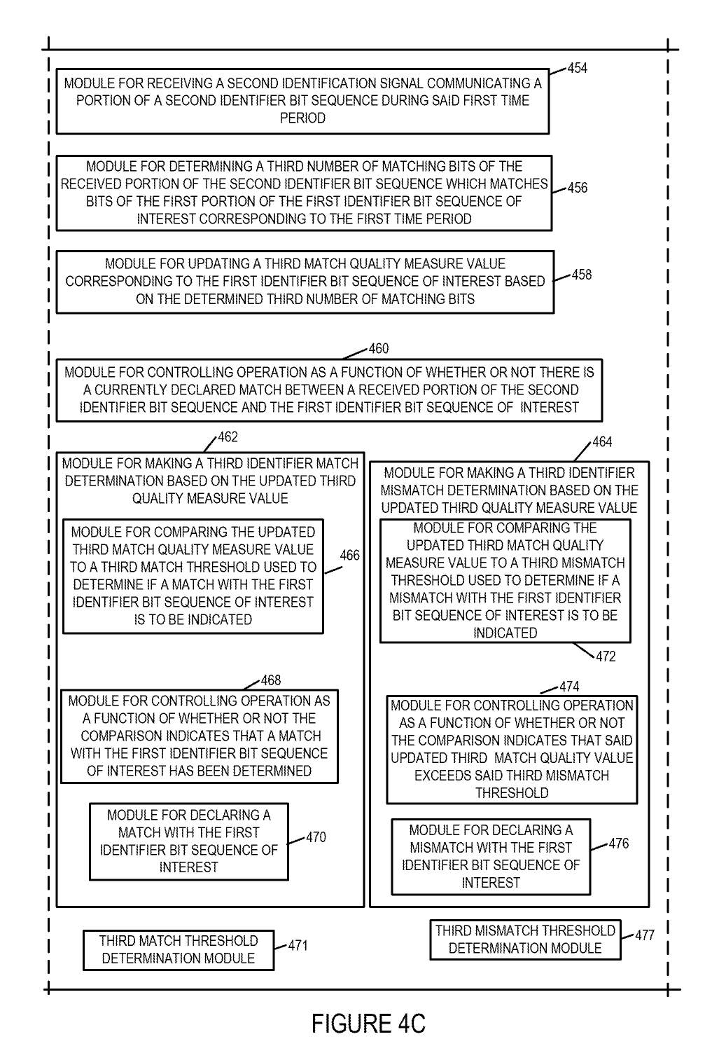

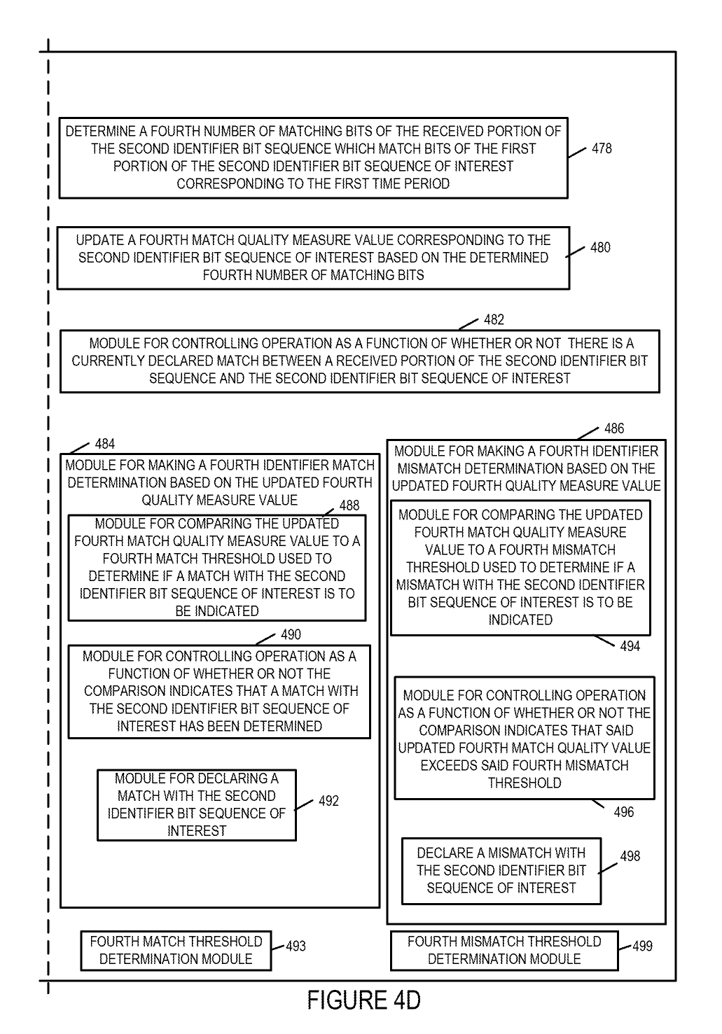

FIG. 4, comprising the combination of FIG. 4A, FIG. 4B, FIG. 4C, and FIG. 4D, is an assembly of modules 400 which can, and in some embodiments is, used in the communications device 300 illustrated in FIG. 3. The modules in the assembly 400 can be implemented in hardware within the processor 302 of FIG. 3, e.g., as individual circuits. Alternatively, the modules may be implemented in software and stored in the memory 304 of the communications device 300 shown in FIG. 3. While shown in the FIG. 3 embodiment as a single processor, e.g., computer, it should be appreciated that the processor 302 may be implemented as one or more processors, e.g., computers. When implemented in software the modules include code, which when executed by the processor, configure the processor, e.g., computer, 302 to implement the function corresponding to the module. In some embodiments, processor 302 is configured to implement each of the modules of the assembly of modules 400. In embodiments where the assembly of modules 400 is stored in the memory 304, the memory 304 is a computer program product comprising a computer readable medium comprising code, e.g., individual code for each module, for causing at least one computer, e.g., processor 302, to implement the functions to which the modules correspond.

Completely hardware based or completely software based modules may be used. However, it should be appreciated that any combination of software and hardware (e.g., circuit implemented) modules may be used to implement the functions. As should be appreciated, the modules illustrated in FIG. 4 control and/or configure the communications device 300 or elements therein such as the processor 302, to perform the functions of the corresponding steps illustrated in the method flowchart 200 of FIG. 2.

Assembly of modules 400 includes a module 404 for receiving a first identification signal communicating a portion of a first identifier bit sequence during a first time period, a module 406 for determining a first number of matching bits of the received portion of the first identifier bit sequence which matches bits of a first portion of a first identifier bit sequence of interest corresponding to the first time period, a module 408 for updating a first match quality measure value corresponding to the first identifier bit sequence of interest based on the determined first number of matching bits, a module 410 for controlling operation as a function of whether or not there is a currently declared match between a received portion of the first identifier bit sequence and the first identifier bit sequence of interest, a module 412 for making a first identifier match determination based on the updated first quality measure value, a module 414 for making a first identifier mismatch determination based on the updated first quality measure value, and a module 424 for monitoring additional identification signals to be processed. Module 412 includes a module 416 for comparing the updated first match quality measure value to a first match threshold used to determine if a match with the first identifier bit sequence of interest is to be indicated, a module 418 for controlling operation as a function of whether or not the comparison indicates that a match with the first identifier bit sequence of interest has been determined, and a module 420 for declaring a match with the first identifier bit sequence of interest. Module 414 includes a module 426 for comparing the updated first match quality measure value to a first mismatch threshold used to determine if a mismatch with the first identifier bit sequence of interest is to be indicated, a module 428 for controlling operation as a function of whether or not the comparison indicates that said updated first match quality value exceeds said first mismatch threshold, and a module 430 for declaring a mismatch with the first identifier bit sequence of interest. Module 420 is, e.g., a module for declaring a match with the first identifier bit sequence of interest when the comparing of module 416 indicates that a match with the first identifier bit sequence of interest has been determined. Module 418, in some embodiments, controls whether or not module 420 is operated based on the result of module 416's comparison. Module 430 is, e.g., a module for declaring a mismatch following declaration of a match with the first identifier bit sequence of interest when the comparing of step 426 indicates the updated match quality value exceeds the first mismatch threshold. Module 428, in some embodiments, controls whether or not module 430 is operated based on the result of module 426's comparison. In some embodiments, module 410 determines whether module 412 is operated or module 414 is operated.

Assembly of modules 400 also includes a first match threshold determination module 421 and a first mismatch threshold determination module 431. In some embodiments, the first match threshold is based on an expected mismatch rate. In some embodiments, the first match threshold is varied as a function of the number of bits used to generate said first match quality measure value. In various embodiments the first match threshold is application dependent. In some embodiments, the first mismatch threshold is based on an expected mismatch rate. In some embodiments, the first mismatch threshold is varied as a function of the number of bits used to generate said first match quality measure value. In various embodiments the first mismatch threshold is application dependent.

Assembly of modules 400 further includes: a module 432 for determining a second number of matching bits of the received portion of the first identifier bit sequence which matches bits of a first portion of a second identifier bit sequence of interest corresponding to the first time period, a module 434 for updating a second match quality measure value corresponding to the second identifier bit sequence of interest based on the determined second number of matching bits, a module 436 for controlling operation as a function of whether or not there is a currently declared match between a received portion of the first identifier bit sequence and the second identifier bit sequence of interest, a module 438 for making a second identifier match determination based on the updated second quality measure value, and a module 440 for making a second identifier mismatch determination based on the updated second quality measure value. Module 438 includes a module 442 for comparing the updated second match quality measure value to a second match threshold used to determine if a match with the second identifier bit sequence of interest is to be indicated, a module 444 for controlling operation as a function of whether or not the comparison indicates that a match with the second identifier bit sequence of interest has been determined, and a module 446 for declaring a match with the second identifier bit sequence of interest. Module 440 includes a module 448 for comparing the updated second match quality measure value to a second mismatch threshold used to determine if a mismatch with the second identifier bit sequence of interest is to be indicated, a module 450 for controlling operation as a function of whether or not the comparison indicates that said updated second match quality value exceeds said second mismatch threshold, and a module 452 for declaring a mismatch with the second identifier bit sequence of interest. Assembly of modules 400 further includes a second match threshold determination module 447 and second mismatch threshold determination module 453.

Assembly of modules 400 also includes a module 454 for receiving a second identification signal communicating a portion of a second identifier bit sequence during said first time period, a module 456 for determining a third number of matching bits of the received portion of the second identifier bit sequence which matches bits of the first portion of the first identifier bit sequence of interest corresponding to the first time period, a module 458 for updating a third match quality measure value corresponding to the first identifier bit sequence of interest based on the determined third number of matching bits, a module 460 for controlling operation as a function of whether or not there is a currently declared match between a received portion of the second identifier bit sequence and the first identifier bit sequence of interest, a module 462 for making a third identifier match determination based on the updated first quality measure value, and a module 464 for making a third identifier mismatch determination based on the updated third quality measure value. Module 462 includes a module 466 for comparing the updated third match quality measure value to a third match threshold used to determine if a match with the first identifier bit sequence of interest is to be indicated, a module 468 for controlling operation as a function of whether or not the comparison indicates that a match with the first identifier bit sequence of interest has been determined, and a module 470 for declaring a match with the first identifier bit sequence of interest. Module 464 includes a module 472 for comparing the updated third match quality measure value to a third mismatch threshold used to determine if a mismatch with the first identifier bit sequence of interest is to be indicated, a module 474 for controlling operation as a function of whether or not the comparison indicates that said updated third match quality value exceeds said third mismatch threshold, and a module 476 for declaring a mismatch with the first identifier bit sequence of interest. Assembly of modules 400 further includes a third match threshold determination module 471 and a third mismatch threshold determination module 477.

Assembly of modules 400 further includes: a module 478 for determining a fourth number of matching bits of the received portion of the second identifier bit sequence which matches bits of a first portion of the second identifier bit sequence of interest corresponding to the first time period, a module 480 for updating a fourth match quality measure value corresponding to the second identifier bit sequence of interest based on the determined fourth number of matching bits, a module 482 for controlling operation as a function of whether or not there is a currently declared match between a received portion of the second identifier bit sequence and the second identifier bit sequence of interest, a module 484 for making a fourth identifier match determination based on the updated fourth quality measure value, and a module 486 for making a fourth identifier mismatch determination based on the updated fourth quality measure value. Module 484 includes a module 488 for comparing the updated fourth match quality measure value to a fourth match threshold used to determine if a match with the second identifier bit sequence of interest is to be indicated, a module 490 for controlling operation as a function of whether or not the comparison indicates that a match with the second identifier bit sequence of interest has been determined, and a module 492 for declaring a match with the second identifier bit sequence of interest. Module 486 includes a module 494 for comparing the updated fourth match quality measure value to a fourth mismatch threshold used to determine if a mismatch with the second identifier bit sequence of interest is to be indicated, a module 496 for controlling operation as a function of whether or not the comparison indicates that said updated fourth match quality value exceeds said fourth mismatch threshold, and a module 498 for declaring a mismatch with the second identifier bit sequence of interest. Assembly of modules 400 further includes a fourth match threshold determination module 493 and a fourth mismatch threshold determination module 499.

In some embodiments, the first identification signal corresponds to a first communications channel, and the second identification signal corresponds to a second communications channel, and the first and second communications channels are different. In some such embodiments module 404 receives the first identification signal on the first communications channel, and module 454 receives the second identification signal on the second communications channel. In some embodiments the first and second communications channels are different peer discovery channels. In some such embodiments the first time period is a peer discovery time period.

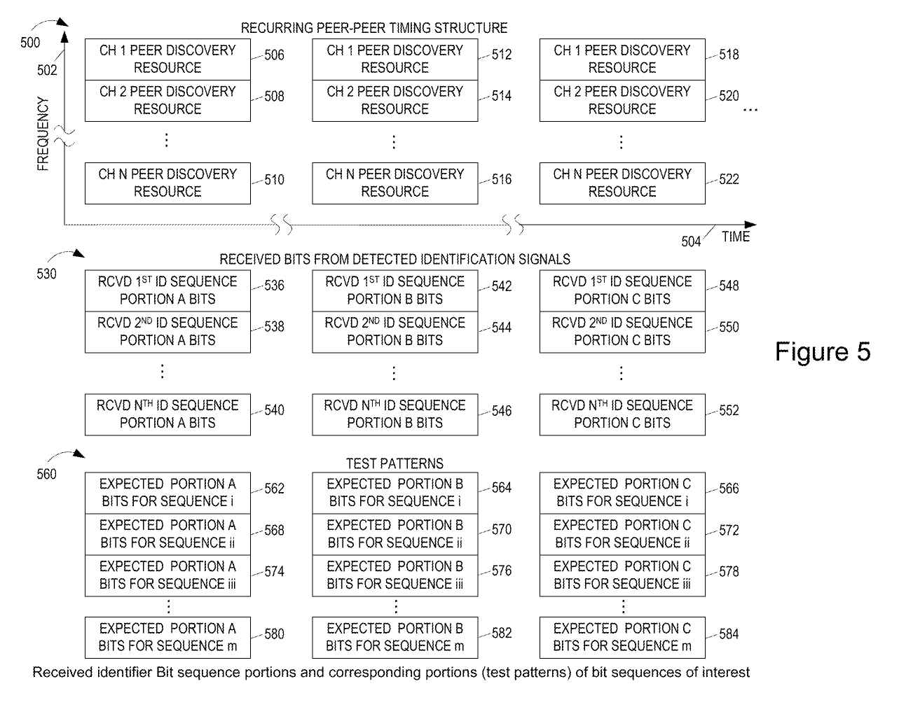

FIG. 5 is a drawing illustrating an exemplary peer to peer recurring timing structure 500, exemplary received bits from detected identification signals 530 and exemplary test patterns 560. Received identifier bit sequence portions, which are received on peer discovery air link resources, are compared to corresponding portions of bit sequences of interest, e.g., test patterns of sequences of interest.

Vertical axis 502 represents frequency, e.g., OFDM tones, while horizontal axis 504 represents time, e.g., OFDM symbol transmission time intervals. The recurring peer to peer timing structure 500 includes sets of peer discovery resources, e.g., sets of peer discovery segments, corresponding to a plurality of communications channels. Peer discovery resources corresponding to communications channel 1 include segments (506, 512, 518). Peer discovery resources corresponding to communications channel 2 include segments (508, 514, 520). Peer discovery resources corresponding to communications channel N include segments (510, 516, 522). Segments (506, 508, 510) correspond to a first peer discovery time period; segments (512, 514, 516) correspond to a second peer discovery time period; segments (518, 520, 522) correspond to an 3rd peer discovery time period. The peer to peer timing structure also includes other types of segments, e.g., paging segments, peer to peer traffic control segments, peer to peer traffic segments, etc.

Consider that a wireless communications device is monitoring the peer discovery resources and obtaining received bits from identification signals communicated on the peer discovery resources. Received 1st ID sequence portion A bits 536 is received over channel 1 peer discovery resource 506. Received 2nd ID sequence portion A bits 538 is received over channel 2 peer discovery resource 508. Received Nth ID sequence portion A bits 540 is received over channel N peer discovery resource 510. Received 1st ID sequence portion B bits 542 is received over channel 1 peer discovery resource 512. Received 2nd ID sequence portion B bits 544 is received over channel 2 peer discovery resource 514. Received Nth ID sequence portion B bits 546 is received over channel N peer discovery resource 516. Received 1st ID sequence portion C bits 548 is received over channel 1 peer discovery resource 518. Received 2nd ID sequence portion C bits 550 is received over channel 2 peer discovery resource 520. Received Nth ID sequence portion C bits 552 is received over channel N peer discovery resource 522.

The communications device stores test patterns corresponding to identifier bit sequences of interest and/or the communications device stores information used to derive test patterns corresponding to identifier bit sequences of interest. Drawing 560 illustrates m exemplary bit sequences of interest. Bit sequence i includes expected portion A bits of sequence i 562, expected portion B bits of sequence i 564, and expected portion C bits of sequence i 566. Bit sequence ii includes expected portion A bits of sequence ii 568, expected portion B bits of sequence ii 570, and expected portion C bits of sequence ii 572. Bit sequence iii includes expected portion A bits of sequence iii 574, expected portion B bits of sequence iii 576, and expected portion C bits of sequence iii 578. Bit sequence m includes expected portion A bits of sequence m 580, expected portion B bits of sequence m 582, and expected portion C bits of sequence m 584.

The communications device performs bit matching of a received identifier bit sequence portion and a corresponding portion of a bit sequence of interest, e.g., for multiple peer discovery time intervals. In various embodiments, entropy coding is used as part of the determination as to whether or not received signals on a particular peer discovery channel are communicating a particular bit sequence of interest.

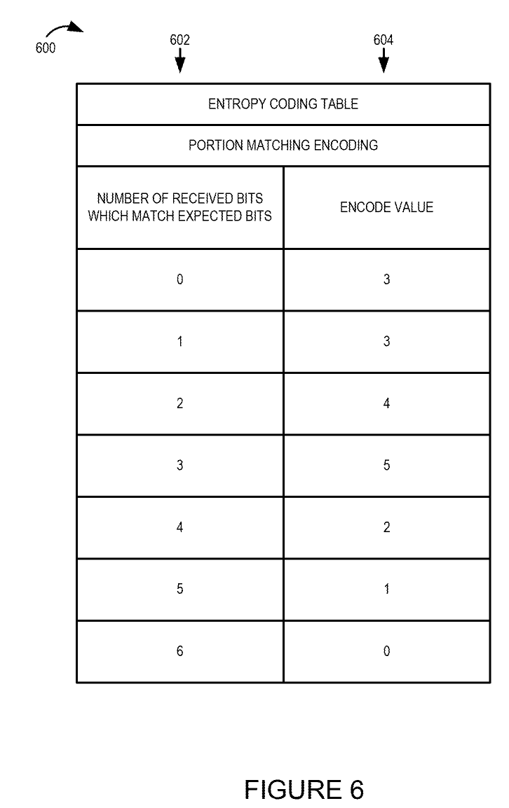

FIG. 6 illustrates an exemplary entropy coding table 600, used in some embodiments, for portion matching encoding. In this example, a bit sequence portion conveys 6 bits. In other embodiments a bit sequence portion conveys a different number of bits. First column 602 lists a number of received bits which match expected bits, while second column 604 lists corresponding encode values. More specifically, a match of (0, 1, 2, 3, 4, 5, 6) bits in a portion results in encode values of (3, 3, 4, 5, 2, 1, 0), respectively, in this example. Note that for a complete bit match, the encode value is the lowest value in the set of encode values, which is 0; while for a 50% bit match, the encode value is the highest value in the set of encode values which is 5.

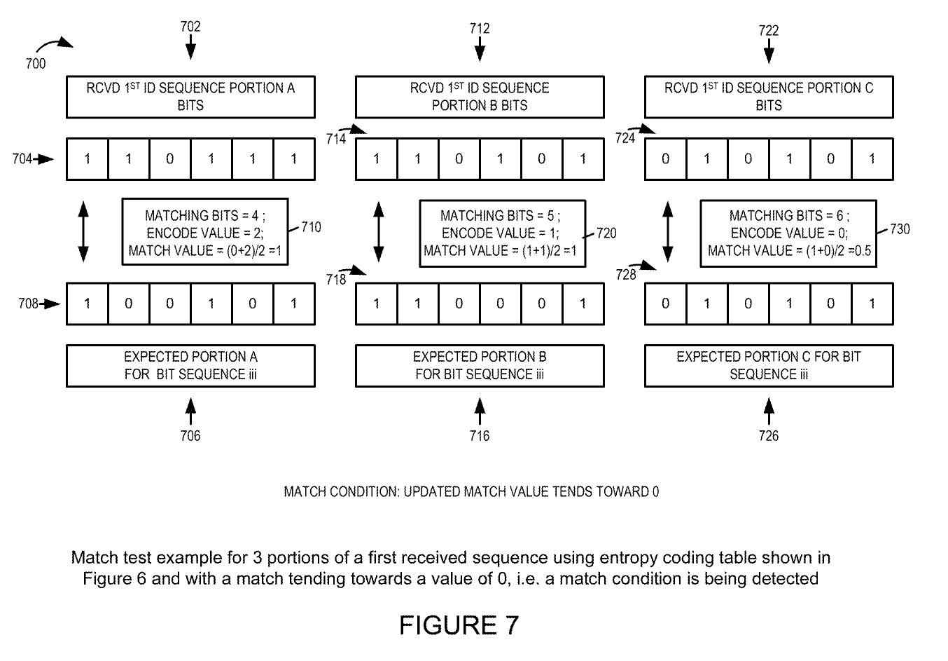

FIG. 7 is a drawing 700 illustrating a match test example for 3 portions of a first received sequence using the entropy coding table shown in FIG. 6 in which a match condition is determined. In this example, the match value tends toward a value of 0 indicating that a match condition has been detected.

In this example, consider that the match value starts at a value of 0; e.g. from initialization or from the result of previous match comparison testing. In some embodiments, the match value is initialized at 5 following power on. In some other embodiments, the match value is initialized at an intermediate value, e.g., 2.5, following power on.

Consider that block 702 represents received 1st ID sequence portion A bits, e.g., received portion A bit corresponding to peer discovery communications channel 1. Drawing 704 represents the bit pattern of received 1st ID sequence portion A bits, which in this example, is 1 1 0 1 1 1. Block 706 represents an expected portion A for bit sequence iii, which is the bit sequence of interest being tested for a match condition. Drawing 708 represents the bit pattern of expected portion A bits for identifier bit sequence iii, which in this example, is 1 0 0 1 0 1. Block 710 indicates bit comparison results, encoding results and an exemplary matching value computation, for portion A. The communications device performs a bit comparison for portion A and determines that 4 bits match. The communications device uses the entropy coding table of FIG. 6 and obtains an encode value of 2. The communications device updates the matching value, where new matching value=(old matching value+encode value)/2. In other embodiments, a different formula is used for the matching value. In various embodiments, the new matching value is a function of an old matching value and an entropy encoded value. In this example, the updated match value=(0+2)/2=1.

Consider that block 712 represents received 1st ID sequence portion B bits, e.g., received portion B bits corresponding to peer discovery communications channel 1. Drawing 714 represents the bit pattern of received 1st ID sequence portion B bits, which in this example, is 1 1 0 1 0 1. Block 716 represents an expected portion B for bit sequence iii. Drawing 718 represents the bit pattern of expected portion B bits for identifier bit sequence iii, which in this example, is 1 1 0 0 0 1. Block 720 indicates bit comparison results, encoding results and an exemplary matching value computation, for portion B. The communications device performs a bit comparison for portion B and determines that 5 bits match. The communications device uses the entropy coding table of FIG. 6 and obtains an encode value of 1. The communications device updates the matching value. In this example, the updated match value=(1+1)/2=1.

Consider that block 722 represents received 1st ID sequence portion C bits, e.g., received portion C bits corresponding to peer discovery communications channel 1. Drawing 724 represents the bit pattern of received 1st ID sequence portion C bits, which in this example, is 0 1 0 1 0 1. Block 726 represents an expected portion C for bit sequence iii. Drawing 728 represents the bit pattern of expected portion C bits for identifier bit sequence iii, which in this example, is 0 1 0 1 0 1. Block 730 indicates bit comparison results, encoding results and an exemplary matching value computation, for portion C. The communications device performs a bit comparison for portion C and determines that 6 bits match. The communications device uses the entropy coding table of FIG. 6 and obtains an encode value of 0. The communications device updates the matching value. In this example, the updated match value=(1+0)/2=0.5. It may be observed that for a match condition the updated match value tends toward 0. In various embodiments, a match threshold may be, and sometimes is, compared to the updated match value to detect a match condition, e.g., an updated match value below or equal to the match threshold indicates a detected match condition. In some embodiments, an updated match value may be, and sometimes is, compared to a mismatch threshold value, to determine if a mismatch condition exists, e.g., an updated match value greater than or equal to the mismatch threshold indicates a mismatch condition.

In some embodiments in one scenario the first time period referred to in flowchart 200 of FIG. 2 refers to the time period in which 1st ID sequence portion A bits 702 are received. In another scenario the first time period referred to in flowchart 200 of FIG. 2 refers to the time period in which 1st ID sequence portion B bits 712 are received. In still another scenario the first time period referred to in flowchart 200 of FIG. 2 refers to the time period in which 1st ID sequence portion C bits 722 are received.

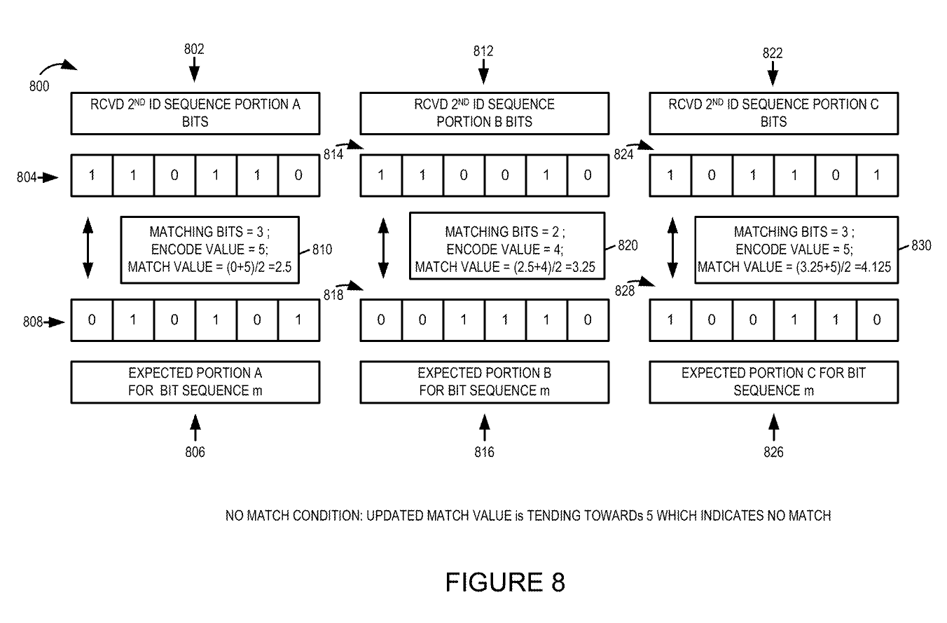

FIG. 8 is a drawing 800 illustrating a match test example for 3 portions of a second received sequence using the entropy coding table shown in FIG. 6 in which a mismatch condition is determined. In this example, the match value tends toward a value of 5 indicating that a mismatch condition has been detected.

In this example, consider that the match value starts at a value of 0; e.g. from initialization or from the result of previous match comparison testing. In some embodiments, the match value is initialized at 5 following power on. In some other embodiments, the match value is initialized at an intermediate value, e.g., 2.5, following power on.

Consider that block 802 represents received 2st ID sequence portion A bits, e.g., received portion A bit corresponding to peer discovery communications channel 2. Drawing 804 represents the bit pattern of received 2nd ID sequence portion A bits, which in this example, is 1 1 0 1 1 0. Block 806 represents an expected portion A for bit sequence m, which is the bit sequence of interest being tested for a match condition. Drawing 808 represents the bit pattern of expected portion A bits for identifier bit sequence m, which in this example, is 0 1 0 1 0 1. Block 810 indicates bit comparison results, encoding results and an exemplary matching value computation, for portion A. The communications device performs a bit comparison for portion A and determines that 3 bits match. The communications device uses the entropy coding table of FIG. 6 and obtains an encode value of 5. The communications device updates the matching value, where new matching value=(old matching value+encode value)/2. In other embodiments, a different formula is used for the matching value. In various embodiments, the new matching value is a function of an old matching value and an entropy encoded value. In this example, the updated match value=(0+5)/2=2.5.

Consider that block 812 represents received 2nd ID sequence portion B bits, e.g., received portion B bits corresponding to peer discovery communications channel 2. Drawing 814 represents the bit pattern of received 2nd ID sequence portion B bits, which in this example, is 1 1 0 0 1 0. Block 816 represents an expected portion B for bit sequence m. Drawing 818 represents the bit pattern of expected portion B bits for identifier bit sequence m, which in this example, is 0 0 1 1 1 0. Block 820 indicates bit compassion results, encoding results and an exemplary matching value computation, for portion B. The communications device performs a bit comparison for portion B and determines that 2 bits match. The communications device uses the entropy coding table of FIG. 6 and obtains an encode value of 4. The communications device updates the matching value. In this example, the updated match value=(2.5+4)/2=3.25.

Consider that block 822 represents received 2nd ID sequence portion C bits, e.g., received portion C bits corresponding to peer discovery communications channel 2. Drawing 824 represents the bit pattern of received 2nd ID sequence portion C bits, which in this example, is 1 0 1 1 0 1. Block 826 represents an expected portion C for bit sequence m. Drawing 828 represents the bit pattern of expected portion C bits for identifier bit sequence m, which in this example, is 1 0 0 1 1 0. Block 830 indicates bit comparison results, encoding results and an exemplary matching value computation, for portion C. The communications device performs a bit comparison for portion C and determines that 3 bits match. The communications device uses the entropy coding table of FIG. 6 and obtains an encode value of 5. The communications device updates the matching value. In this example, the updated match value=(3.25+5)/2=4.125. It may be observed that for a mismatch condition, the updated match value tends toward 5. In various embodiments, a match threshold may be, and sometimes is, compared to the updated match value to detect a match condition, e.g., an updated match value below or equal to the match threshold indicates a detected match condition. In some embodiments, an updated match value may be, and sometimes is, compared to a mismatch threshold value, to determine if a mismatch condition exists, e.g., an updated match value greater than or equal to the mismatch threshold indicates that a mismatch condition exists.

In some embodiments in one scenario the first time period referred to in flowchart 200 of FIG. 2 refers to the time period in which 2nd ID sequence portion A bits 802 are received. In another scenario the first time period referred to in flowchart 200 of FIG. 2 refers to the time period in which 2nd ID sequence portion B bits 812 are received. In still another scenario the first time period referred to in flowchart 200 of FIG. 2 refers to the time period in which 2nd ID sequence portion C bits 822 are received.

Various embodiments are directed to the problem of determining if a received bit sequence matches a bit sequence of interest where portions of the received bit sequence may be received at different times. The bit sequence of interest may correspond to an identifier which a device is looking for. It would be desirable to make a decision based on one or more portions, e.g., received in different discovery time intervals which have been received up until the present time. While the problem applies in the case of a single received bit sequence, in many applications multiple bit sequences are received and multiple identifiers are of interest. Accordingly, various embodiments are directed to methods and apparatus which can be used in such a situation.

Methods and apparatus for determining if received portions of identifier bit sequences match one or more identifier bit sequences of interest are described. To make it possible for devices to advertise information without making the information readily detectable to devices for which the information is not intended, identifier sequences are designed to appear random. Devices which are intended to be able to detect the identifier bit sequences are provided sufficient information, e.g., a key or other information, to enable them to generate the identifier bit sequence they may seek to discover. Thus, identifier bit sequences and their meaning are known to devices which advertise, e.g., transmit, the sequences and to devices which are intended to receive and understand what the transmitted identifier bit sequences correspond to. Devices may monitor for and attempt to detect one or more identifier bit sequences which correspond to a device, service, item or thing of interest to the monitoring device. Devices which have not been provided with information sufficient to enable the generation of a particular identifier bit sequence, received identifier bit sequences which they receive will appear random. Thus, devices can advertise information to other devices which they want to be able to detect the advertised information while keeping the advertised information from other devices in the system.

Various embodiments are directed to methods and apparatus which allow a monitoring device to detect a transmitted identifier bit sequence corresponding to a bit sequence of interest. A device receiving a portion of a transmitted identifier bit sequence compares the bits of the received portion of the transmitted identifier bit sequence to the bits of a corresponding portion of a bit sequence of interest, e.g., a bit sequence corresponding to an identifier of interest. The transmitted bit sequences are designed to appear random in nature. Accordingly, if a transmitted bit sequence is different from a bit sequence of interest, there should be a 50% probability, on a per bit basis, that bits in received identifier sequence portions will not match the bits of the corresponding portions of the identifier sequences of interest. If there is a match, assuming few transmission errors, the match on a per bit basis should near 100%. However, the actual match rate may be lower depending on the number of transmission errors and may vary for different portions of a received bit sequence, e.g., due to signal interference which may occur in bursts.

Based on the number of matching bits, a match quality measure value is updated. The updating of the match quality measure value may involve a weighting process, e.g., the match quality measure value may be an average or weighted average.

In some but not all embodiments, updating of the match quality measure value involves performing an entropy coding operation on the number of bits which have been determined to match. In other embodiments entropy coding is not used. The number of bits which have been determined to match is referred to as the matching number of bits. The entropy coded value of the matching number of bits may then be added, as part of a process of generating a weighted average, to a current match quality measure value to produce the updated match quality measure value. A match determination, e.g., a determination whether bits of received portions of a transmitted bit sequence match a particular bit sequence of interest may be based on a match determination threshold to which an updated match quality measure is compared. Once a match is declared between one or more received portions of a bit sequence and a particular bit sequence of interest, a second threshold is used to determine if the match should be undeclared based on an updated match quality measure value generated based on a portion of the bit sequence that is received subsequent to the declaration of the match.

The use of two thresholds allows for rapid declaration of a match while the match may be undeclared based on another threshold as the updated match quality measure improves and converges towards an expected value as additional received portions of the bit sequence for which a match was declared are received and processed.

In various embodiments the match quality measure used to determine if a match should be declared will converge to one of two values depending on whether or not there is a match. In some embodiments, different match determination thresholds are used depending on the number of received bits which have contributed to generating the updated match quality measure. For example, in one exemplary embodiment, a different match determination threshold value is used when a single received portion of a transmitted bit sequence has been used to generate the updated match quality measure and a different threshold is used after multiple portions of the transmitted bit sequence have been received and used to update the match quality measure.

In some embodiments, a device seeking to communicate discovery information transmits different portions of an identifier bit sequence at different times, e.g., during different peer to peer discovery time intervals. Different devices may transmit different identifier bit sequences, e.g., with each of the different transmitted bit sequences corresponding to a different identifier or item to be advertised. As discussed above, devices seeking to discover other devices or services know an identifier bit sequence corresponding to the device or service they want to discover and what portion of the identifier bit sequence of interest is to be transmitted in a particular time period.

In various embodiments, portions of transmitted identifier bit sequences are received. The received portions, e.g., of one or more transmitted identifier bit sequences, are compared to corresponding portions of one or more identifier bit sequences of interest. Thus, the bits of the one or more identifier bit sequences of interest serve as test bits which are used to determine if a bit sequence being transmitted matches a bit sequence of interest. In some embodiments, a device monitoring different transmitted bit sequences maintains a different match quality measure for each bit sequence on a per bit sequence of interest basis. Thus, a device receiving bit sequences may, and in some embodiments does, maintain N times M match quality measures, where N is the number of transmitted bit sequences being monitored and M is the number of bit sequences of interest the receiving device is seeking to identify in received signals. To reduce the storage requirements, in some but not all embodiments only match quality measures deemed sufficiently likely to indicate a match will be explicitly stored. In at least one such embodiment all other combinations of signal-ID pairs having an effective null match quality measure are not stored.

Various aspects are directed to new method and apparatus related to discovery and, more specifically, coding for discovery. In some embodiments the discovery is peer discovery in a wireless peer to peer communications system. In some embodiments, a fundamental premise of discovery is that a receiver is trying to match the observed received values against a set of stored IDs. One would like bits to be delivered reliably in the Peer Discovery channel, and then perform matching. However, in some embodiments, the bits come in small chunks, and it is very costly to achieve reliability for those bits.

The ID sequences that are to be matched with, in some embodiments, e.g., in some cases of private encrypted IDs, form random-looking bit strings that are transmitted in time. The IDs that generate these strings may be some fixed size, say 128 bits. One can view the pseudo-random strings as an (virtually) infinitely extensible random code which encodes the 128 bit ID. The effective rate of the code depends on the length of observation time interval. As observation time increases the code rate becomes effectively lower, and lower rate can, in principle, “correct” more errors.

If one views the bits received on a local ID as bits of the underlying pseudo-random code delivered over a channel, then the matching process resembles brute-force maximum likelihood (ML) decoding except that the receiver looks only at the codewords (IDs) it is interested in and not at the entire code. This restriction does not fundamentally degrade performance, however, since the rate of the code is tending to zero and the code is essentially random. In some embodiments, one determines probabilities for the various error events (false positive, false negative) in the appropriate senses and declares detection with any desired reliability or bound on the various error rates. The price for more certainty from this process is observation time. In some embodiments, one can, and sometimes does, observe the signal longer to achieve greater reliability.

In some embodiments, a characteristic of the approach is that each of the IDs when transmitted appears essentially randomly coded. In some embodiments, fixed IDs are expanded into a reasonably long code, e.g., using some simple random number generator with ID seeding the process appropriately, and then the code is repeated periodically. In some embodiments, a device need not, and does not, store the codes, e.g., as long as the generation mechanism is simple.

This has implications in that continuity of ID representation over the air is important. The “small chunks” of ID transmission corresponding to an ID, in some embodiments, are not independent.

One effect of this approach is that SNR impacts rate of detection (for a given reliability). Higher SNR means a higher rate of reliable detection. In general this approach can increase the range and robustness of peer discovery over other approaches. In addition the processing used for detection in this approach is simple.

Various features of some embodiments will be described by example. An exemplary device is observing K local IDs and has N IDs it is trying to match. Consider that the exemplary embodiment uses independent random sequences and hard decision tracking. Soft decision correlation, used in some embodiments, can give somewhat better performance; however, it increases complexity. One exemplary embodiment uses antipodal representation for the bits: +1 for bit match, −1 for mismatch. We assume noise causes error rate (i.e., flipping in the channel) p. For a random ID (different from the transmitted one) the bit match sequence is modeled as sequence of independently identically distributed Bernoulli ½ random variables. After summing n match bits the sum is a nearly Gaussian random variable (actually Binomial) with mean 0 and variance n. If the transmitted ID is on our list of IDs of interest then, for that ID, the bit match sequence is Bernoullip. (Probability p of −1 (mismatch).) After n bits the sum is nearly Gaussian (Binomial) with mean (1−p)n with variance n. Assuming a threshold t=t(n) we can consider various probabilities and thereby determine the statistics of the match declaration process.

The probability that a random sequence produces a sum larger than t at time n is

$$Q ( \frac{t}{\sqrt{n}} )$$

where Q is the well-known Q function. The probability that a matching sequence produces a sum smaller than t at time n is

$$Q ( \frac{t - pn}{\sqrt{p ( 1 - p ) n}} ) .$$

For example, if at time n we declare a match on this local ID when the sum for any of the IDs on our list exceeds t then the probability of a false declaration at time t is (assuming t2/n reasonably large)

$$1 - {( 1 - Q ( \frac{t}{\sqrt{n}} ) )}^{N} ≃ N \frac{1}{2} {e}^{- {t}^{2} / n}$$

The probability that the matching sequence does not exceed t is

$$Q ( \frac{t - ( 1 - p ) n}{\sqrt{p ( 1 - p ) n}} ) ≃ \frac{1}{2} {e}^{{( t - ( 1 - p ) n )}^{2} / p ( 1 - p ) n}$$

If we let t grow linearly in n at rate less than (1−p), say

$$t = \frac{1 - p}{2} n$$

then these errors go to zero exponentially fast in n. Furthermore, the smaller p give better values for the second exponent.

In the case of 0 dB SNR, for example, the expected bit error rate for coherent uncoded QPSK is 16%. Over time this is easily distinguished from random mismatch (50% error rate) with arbitrarily high probability. Thus, peer discovery at 0 dB is feasible.

An exemplary receiver structure in accordance with some embodiments will now be described. For each (unidentified) local ID the receiver maintains a list of ID matches that are sufficiently good. An element of the list would indicate where the match began (t=0) and the “score” so far. The score, in some embodiments, is essentially the sum. In some embodiments, the score is normalized and/or filtered. To control the complexity admission to the list is fairly stringent.

Independently, the local ID has an associated SNR estimate, but we may assume that it is not very accurate. For the purposes here, the SNR estimate provides a BER estimate. A member of the list will be dropped if the score is sufficiently bad, i.e., if the match rate is too far below expected error rates. Aggressiveness on this point is tied primarily to complexity concerns: for mismatches the BER should converge to 50% reasonably quickly. Low SNR cases will need to allow more errors so list sizes will tend to be larger.

If bits come in k bits chunks then, in one embodiment, to enter the list, the receiver requires an exact match on k bits. In general the receiver may use a function ƒ(n) which says essentially how many bit matches are required after the nth chunk in order to be (remain) on the list. This function, in various embodiments, also depends on the estimated SNR, although the dependence will likely not be very strong. The concerns here are the rate at which correct matches are dropped from the list, which would be preferably kept small, and the false match list statistics e.g, the size of the lists. The rate of false matches is another important quantity. It depends on the criteria for declaring a match, and not necessarily the criteria for maintenance on the list, although, maintenance on the list would be necessary for declaration of a match. Some embodiments include the use of intentional NULL symbols in which the transmission of the bit sequence is temporarily suspended. In some such embodiments, e.g., in the case of bits coded in the location of the NULL symbol and the location of the NULL symbol unknown to the receiver, the receiver may include in the match quality measure associated to detection of the NULL symbol which will be different than the usual match quality measure update.

Some embodiments, e.g., embodiments which implement peer discovery at higher rates, especially at short distances, use larger QAM constellations to carry discovery signals. Assuming Gray mapping there are k levels of bits in the 2^{2k} constellation with different BERs. This is taken into account in the matching process. The impact of SNR on time for discovery could be even more pronounced. Roughly speaking, a receiver at sufficiently low SNR may effectively match with only the best of the k bits and so be receiving at a rate 1/k smaller than possible. Since the “codes” are pseudo random the only effect of this is to slow the rate of discovery.

Some embodiments include hierarchical IDs in the sense that substrings (e.g. each lth bit) represent ID classes. The main effect of this is to complicate the matching process. Any duplication of the matching process, i.e., different formats of strings to be matched, should be avoided however since the complexity impact of multiple matching processes is multiplicative. The additional complexity increases as the number of local IDs times the number of different matching formats.

Given the choice of function ƒ(n) that determines maintenance of lists indicating match quality measures and the various states associated to a match, a stochastic matching process is effectively defined. A random received local ID grows and prunes list elements in a random fashion according to the function ƒ(n) which determines list admission, maintenance, and removal. Memory size and/or memory allocation, in some embodiments, is based on knowledge of the statistics of both the size and contents of the list. In some embodiments, a hard limit is enforced, e.g., only one or two candidate matches at a time for a given sought ID. In any case the probability of a large list should be small and this will in general depend on the form of ƒ(n). Longer lists will result in fewer missed matches but will cost more in memory.

The techniques of various embodiments may be implemented using software, hardware and/or a combination of software and hardware. In some embodiments, modules are implemented as physical modules. In some such embodiments, the individual physical modules are implemented in hardware, e.g., as circuits, or include hardware, e.g., circuits, with some software. In other embodiments, the modules are implemented as software modules which are stored in memory and executed by a processor, e.g., general purpose computer. Various embodiments are directed to apparatus, e.g., stationary wireless nodes, mobile nodes such as mobile access terminals of which cell phones are but one example, access point such as base stations including one or more attachment points, servers, and/or communications systems. Various embodiments are also directed to methods, e.g., method of controlling and/or operating wireless communications devices including mobile and/or stationary nodes, access points such as base stations, server nodes and/or communications systems, e.g., hosts. Various embodiments are also directed to machine, e.g., computer, readable medium, e.g., ROM, RAM, CDs, hard discs, etc., which include machine readable instructions for controlling a machine to implement one or more steps of a method.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In various embodiments nodes described herein are implemented using one or more modules to perform the steps corresponding to one or more methods, for example, receiving a first identification signal communicating a portion of a first identifier bit sequence during a first time period; determining a first number of matching bits of the received portion of the first identifier bit sequence which match bits of a first portion of a first identifier bit sequence of interest corresponding to said first time period; and updating a first match quality measure value corresponding to the first identifier bit sequence of interest based on the determined first number of matching bits.

Thus, in some embodiments various features are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium including machine executable instructions for causing a machine, e.g., processor and associated hardware, to perform one or more of the steps of the above-described method(s). Some embodiments are directed to a device, e.g., communications device, including a processor configured to implement one, multiple or all of the steps of one or more methods of the invention.

Some embodiments are directed to a computer program product comprising a computer-readable medium comprising code for causing a computer, or multiple computers, to implement various functions, steps, acts and/or operations, e.g. one or more steps described above. Depending on the embodiment, the computer program product can, and sometimes does, include different code for each step to be performed. Thus, the computer program product may, and sometimes does, include code for each individual step of a method, e.g., a method of controlling a communications device or node. The code may be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device or other device described in the present application.

In some embodiments, the processor or processors, e.g., CPUs, of one or more devices, e.g., communications devices such as wireless terminals are configured to perform the steps of the methods described as being performed by the communications device. Accordingly, some but not all embodiments are directed to a device, e.g., communications device, with a processor which includes a module corresponding to each of the steps of the various described methods performed by the device in which the processor is included. In some but not all embodiments a device, e.g., communications device, includes a module corresponding to each of the steps of the various described methods performed by the device in which the processor is included. The modules may be implemented using software and/or hardware.

While various features are described in the context of an OFDM system, at least some of the methods and apparatus of various embodiments are applicable to a wide range of communications systems including many non-OFDM and/or non-cellular systems.

Numerous additional variations on the methods and apparatus of the various embodiments described above will be apparent to those skilled in the art in view of the above description. Such variations are to be considered within the scope. The methods and apparatus may be, and in various embodiments are, used with CDMA, orthogonal frequency division multiplexing (OFDM), GSM and/or various other types of communications techniques which may be used to provide wireless communications links, e.g., WAN wireless communications links, between access points and wireless communications device such as mobile nodes and wireless communications. The methods and apparatus may be, and in various embodiments are, used with CDMA, orthogonal frequency division multiplexing (OFDM), GSM and/or various other types of communications techniques which may be used to provide wireless communications links, e.g., direct peer to peer wireless communications links, between wireless communications devices including peer to peer interfaces. In some embodiments a wireless communications device including both a wide area network interface and a peer to peer network interface uses different communications techniques for the different interfaces, e.g., one of CDMA and GSM based techniques for the WAN interface and OFDM based techniques for the peer to peer interface. In some embodiments the access points are implemented as base stations which establish communications links with mobile nodes using CDMA, GSM and/or OFDM. In various embodiments the mobile nodes are implemented as notebook computers, personal data assistants (PDAs), or other portable devices including receiver/transmitter circuits and logic and/or routines, for implementing the methods.

What is claimed is:

1. An identifier detection method, the method comprising:
receiving a first identification signal communicating a portion of a first identifier bit sequence during a first time period;
determining a first number of matching bits of the received portion of the first identifier bit sequence which match bits of a first portion of a first identifier bit sequence of interest corresponding to said first time period; and
updating a first match quality measure value corresponding to the first identifier bit sequence of interest based on the determined first number of matching bits.

2. The method of claim 1, further comprising:
making a first identifier match determination based on said updated first quality measure value.

3. The method of claim 1, wherein making a first identifier match determination includes:
comparing the updated first match quality measure value to a first match threshold used to determine if a match with the first identifier bit sequence of interest is to be indicated; and
declaring a match with the first identifier bit sequence of interest when said comparing indicates that a match with the first identifier bit sequence of interest has been determined.

4. The method of claim 3, wherein the first match threshold is based on an expected mismatch rate.

5. The method of claim 4, wherein the first match threshold is varied as a function of the number of bits used to generate said first match quality measure value.

6. The method of claim 5, wherein the first match threshold is application dependent.

7. The method of claim 1, further comprising:
comparing an updated first match quality measure value to a first mismatch threshold used to determine if a mismatch with the first identifier bit sequence of interest is to be indicated; and
declaring a mismatch following declaration of a match with the first identifier bit sequence of interest, when said comparing indicates that said updated match quality measure value exceeds said first mismatch threshold.

8. A communications device comprising:
means for receiving a first identification signal communicating a portion of a first identifier bit sequence during a first time period;
means for determining a first number of matching bits of the received portion of the first identifier bit sequence which match bits of a first portion of a first identifier bit sequence of interest corresponding to said first time period; and
means for updating a first match quality measure value corresponding to the first identifier bit sequence of interest based on the determined first number of matching bits.

9. The communications device of claim 8, further comprising:
means for making a first identifier match determination based on said updated first quality measure value.

10. The communications device of claim 8, wherein said means for making a first identifier match determination includes:
means for comparing the updated first match quality measure value to a first match threshold used to determine if a match with the first identifier bit sequence of interest is to be indicated; and
means for declaring a match with the first identifier bit sequence of interest when said comparing indicates that a match with the first identifier bit sequence of interest has been determined.

11. The communications device of claim 10, wherein the first match threshold is based on an expected mismatch rate.

12. The communications device of claim 11, wherein the first match threshold is varied as a function of the number of bits used to generate said first match quality measure value.

13. The communications device of claim 12, wherein the first match threshold is application dependent.

14. The communications device of claim 8, further comprising:
means for comparing an updated first match quality measure value to a first mismatch threshold used to determine if a mismatch with the first identifier bit sequence of interest is to be indicated; and
means for declaring a mismatch following declaration of a match with the first identifier bit sequence of interest, when said comparing indicates that said updated match quality measure value exceeds said first mismatch threshold.

15. A computer program product for use in a communications device, the computer program product comprising:
a computer readable medium comprising:
code for causing at least one computer to receive a first identification signal communicating a portion of a first identifier bit sequence during a first time period;
code for causing said at least one computer to determine a first number of matching bits of the received portion of the first identifier bit sequence which match bits of a first portion of a first identifier bit sequence of interest corresponding to said first time period; and
code for causing said at least one computer to update a first match quality measure value corresponding to the first identifier bit sequence of interest based on the determined first number of matching bits.

16. A communications device comprising:
at least one processor configured to:
receive a first identification signal communicating a portion of a first identifier bit sequence during a first time period; and
determine a first number of matching bits of the received portion of the first identifier bit sequence which match bits of a first portion of a first identifier bit sequence of interest corresponding to said first time period; and
update a first match quality measure value corresponding to the first identifier bit sequence of interest based on the determined first number of matching bits;
and memory coupled to said at least one processor.

17. The communications device of claim 16, wherein said at least one processor is further configured to:
make a first identifier match determination based on said updated first quality measure value.

18. The communications device of claim 16, wherein said at least one processor is configured to:
compare the updated first match quality measure value to a first match threshold used to determine if a match with the first identifier bit sequence of interest is to be indicated; and
declare a match with the first identifier bit sequence of interest when said comparing indicates that a match with the first identifier bit sequence of interest has been determined,
as part of being configured to make a first identifier match determination.

19. The communications device of claim 18, wherein the first match threshold is based on an expected mismatch rate.

20. The communications device of claim 19, wherein the first match threshold is varied as a function of the number of bits used to generate said first match quality measure value.
